(19) United States
(12) Patent Application Publication
(10) Pub. No.: US 2025/0145198 A1
(43) Pub. Date: May 8, 2025

(54) COORDINATED CONTROL METHOD FOR URBAN RAIL TRANSIT PASSENGER FLOW, ELECTRONIC DEVICE, AND STORAGE MEDIUM

(71) Applicant: SHENZHEN URBAN TRANSPORT PLANNING CENTER CO., LTD., SHENZHEN (CN)

(72) Inventors: XIAOCHUN ZHANG, SHENZHEN (CN); TAO LIN, SHENZHEN (CN); YUXING YANG, SHENZHEN (CN); ZHENWU CHEN, SHENZHEN (CN); XING LIU, SHENZHEN (CN); QIAN KAN, SHENZHEN (CN); YONG ZHOU, SHENZHEN (CN)

(21) Appl. No.: 18/950,191

(22) Filed: Nov. 18, 2024

Related U.S. Application Data
(63) Continuation of application No. PCT/CN2024/111199, filed on Aug. 9, 2024.

(30) Foreign Application Priority Data
Nov. 7, 2023 (CN) 202311464423.4

(51) Int. Cl. B61L 27/16; G06F 30/20; G06F 111/10

(52) U.S. Cl. CPC B61L 27/16; G06F 30/20; G06F 2111/10

(57) ABSTRACT

Disclosed are a coordinated control method for urban rail transit passenger flow, an electronic device, and a storage medium. The method includes: predicting passenger flow in peak hours of urban rail lines using a simulation deduction function in a rail simulation system, including station entry ID, station exit ID, station entry time period, and passenger number data; obtaining passenger flow of passengers arriving at stations s and preparing to board during time periods t by dividing according to the different time periods t and the stations s; counting passenger flow in each direction of historical passenger flow, and calculating a proportion of the passenger flow in each direction of the historical passenger flow; constructing a mixed integer programming model of multi-station passenger flow coordinated control; and obtaining an optimal station entry passenger flow scheme by solving the mixed integer programming model of multi-station passenger flow coordinated control.

### TECHNICAL FIELD

The present disclosure belongs to the technical field of rail transit control, and specifically relates to a coordinated control method for urban rail transit passenger flow, an electronic device, and a storage medium.

### BACKGROUND

During the peak-hour operation period of urban rail transit, passenger flow at key stations increases sharply. Moreover, due to interconnections between various rail transit stations and limitations of rail transportation capacity, when a rail train arrives at a key station, a remaining capacity of the train after passengers get off is too small, resulting in waiting passengers at the station being stranded on the platform. Even if the number of waiting passengers at the station is not large, more and more passengers are stranded as time goes on. When the platform capacity reaches a threshold, a waiting danger coefficient increases, which may easily lead to dangerous accidents. Therefore, according to the passenger flow distribution at key stations on a line, passenger flow restriction measures need to be implemented in advance at corresponding rail transit stations, to reserve part of the train transportation capacity for subsequent rail transit stations, so as to make the overall passenger flow are more balanced.

At present, there are two solutions to the problem of coordinated control of rail transit passenger flow:
1. Manually adjusting station control measures: based on the stranding situation of passenger flow, control is divided into three levels according to control intensities: level 1 passenger flow control, level 2 passenger flow control, and level 3 passenger flow control, where the level 1 passenger flow control is mainly used to control the speed at which passengers enter a platform, and includes: setting up crowd control barriers at the escalators leading to the platform, or controlling the number and operating direction of escalators leading to the platform; the level 2 passenger flow control includes: setting up crowd control barriers at entrances or security checkpoints, and closing some gates or automatic ticket machines, so as to reduce the speed at which passengers enter a rail transit station or paid area; and the level 3 passenger flow control includes: closing some entrances to prevent passengers from entering the station; and metro staff flexibly and quickly make adjustment strategies for passenger flow control based on actual operating conditions. However, the number of passengers restricted is often based on manual experience, and collaboration with other stations is mostly through phone calls and work groups, which cannot guarantee the accuracy and timeliness of passenger flow restriction.
2. Performing coordinated passenger flow restriction of multiple stations: by abstracting a scenario, a mathematical model is established, and the matching degree of transportation capacity and transport volume is improved by optimizing a transportation organization scheme of trains. According to different spatial and temporal distributions of passenger flow, an optimization model of multi-station passenger flow coordinated control is established to control the number of passengers entering the station in a unit time interval, so as to better adapt to the train transportation capacity, improve the coordination and matching degree between passenger flow demand and transportation capacity supply, and alleviate the contradiction between passenger flow demand and transportation capacity supply.

Rail transit passenger flow is controlled and optimized by establishing a model, usually including the following steps: first, performing analysis based on spatial and temporal distribution characteristics of urban rail transit passenger flow, and abstracting scenario assumptions for lines with unbalanced distribution of passenger flow demands; then, establishing a mathematical model, and in consideration of conditions such as passenger flow demand restriction, station capacity restriction, train capacity restriction, etc., taking indicators to be improved as optimization objectives of the model, for example, maximized passenger turnover and minimized total passenger delay; and finally, solving an optimal solution of the model using a heuristic algorithm or an exact solving algorithm. However, although the establishment of the model is based on data theory, the impact of passenger delays at different stations and the impact of transfer passenger flow on passenger flow restriction are not considered simultaneously.

### SUMMARY

In order to achieve a purpose of passenger flow control without increasing transportation capacity in response to the unbalanced spatial and temporal distribution of passenger flow in peak hours of urban rail transit, the present disclosure provides a coordinated control method for urban rail transit passenger flow, an electronic device, and a storage medium.

In order to achieve the above purpose, the present disclosure is implemented through the following technical scheme.

In a first aspect, the present disclosure provides a coordinated control method for urban rail transit passenger flow, including the following steps:
S1, acquiring predicted passenger flow in peak hours of lines using a rail simulation system, and predicting passenger flow in peak hours of urban rail lines using a simulation deduction function in the rail simulation system, including station entry ID, station exit ID, station entry time period, and passenger number data; and dividing a time interval from the start to the end of the peak hours into a set of time periods with a 5-minute step, denoted as T;
S2, obtaining, based on the predicted passenger flow in peak hours of urban rail lines obtained in step S1, passenger flow A_{t,s} of passengers arriving at stations s and preparing to board in time periods t by dividing according to the different time periods t and the stations s; and
counting passenger flow in each direction of the historical passenger flow according to historical passenger flow sorting data of a metro operation company, and obtaining a passenger flow proportion q_{t,s}_{ₒ}_{,s}_{_{d}} of passengers departing from an o^{th} station sₒ and arriving at a d^{th} station s_{d} in the time periods t by calculating a proportion of the passenger flow in each direction of the historical passenger flow;
S3, constructing a mixed integer programming model of multi-station passenger flow coordinated control; and
S4, obtaining an optimal station entry passenger flow scheme by solving the mixed integer programming model of multi-station passenger flow coordinated control constructed in step S3 using a branch and bound algorithm.

Further, obtaining the passenger flow proportion q_{t,s}_{ₒ}_{,s}_{_{d}} of passengers departing from the o^{th} station sₒ and arriving at the d^{th} station s_{d} in the time periods t by calculating the proportion of the passenger flow in each direction of the historical passenger flow in step S2 specifically includes the following step:
denoting a number of passengers departing from the o^{th} station sₒ and arriving at the d^{th} station s_{d} in the time periods t in a data set as O_{t,s}_{ₒ}_{,s}_{_{d}}, and denoting a number of all passengers departing from the o^{th} station sₒ as Q_{t,s}_{ₒ}, so the calculation expression of the passenger flow proportion q_{t,s}_{ₒ}_{,s}_{_{d}} of the passengers departing from the o^{th} station sₒ and arriving at the d^{th} station s_{d} in the time periods t is:

$${q}_{t , {s}_{o} , {s}_{d}} = \frac{{O}_{t , {s}_{o} , {s}_{d}}}{{Q}_{t , {s}_{o}}} .$$

Further, step S3 specifically includes the following steps:
S3.1, constructing the mixed integer programming model of multi-station passenger flow coordinated control, with the calculation expression as follows:

$$min {\sum }_{t ∈ T} {\sum }_{s ∈ S} {A}_{t , s} ( {D}_{t , s} - {P}_{t , s} )$$

where min represents a minimization function, and S represents a set of stations;
D_{t,s} represents an actual boarding demand at the stations s in the time periods t, including a number of passengers arriving at the stations in the time periods t and a number of passengers stranded in previous time periods, which is an integer variable of the mixed integer programming model of multi-station passenger flow coordinated control; and
P_{t,s} represents an optimal number of passengers who board at the stations s in the time periods t, which is an integer variable of the mixed integer programming model of multi-station passenger flow coordinated control; and
S3.2, constructing constraints of the mixed integer programming model of multi-station passenger flow coordinated control.

Further, step S3.2 specifically includes the following steps:
S3.2.1, setting an actual boarding demand for passenger flow in a first time period at the beginning of peak hours to be equal to passenger flow of passengers arriving at the stations and preparing to board in the first time period at the beginning of the peak hours, with the calculation expression as follows:

D_{1,s}=A_{1,s},∀s∈S
where D_{1,s} represents the actual boarding demand at the stations s in the first time period at the beginning of the peak hours, and A_{1,s} represents the passenger flow of passengers arriving at the stations s and preparing to board in the first time period at the beginning of the peak hours;
S3.2.2, setting an actual boarding demand for passenger flow in a certain time period t to be equal to a sum of passenger flow of passengers arriving at the stations and preparing to board in the certain time period t and passenger flow of passengers stranded in a previous time period of the certain time period t, with the calculation expression as follows:

$${D}_{t , s} = {A}_{t , s} + ( {D}_{t - 1 , s} - {P}_{t - 1 , s} ) , ∀ s ∈ S , ∀ t ∈ T , t > 1$$

where D_{t-1,s} represents the actual boarding demand at the stations s in the previous time period of the certain time period t, and P_{t-1,s} represents an optimal number of passengers boarding at the stations s in the previous time period of the certain time period t;
S3.2.3, setting an upper/lower bound of optimal station entry passenger flow, where a value of the upper/lower bound of the optimal station entry passenger flow is greater than or equal to 0.15 times of the actual boarding passenger flow, and less than or equal to the actual boarding passenger flow, with the calculation expression as follows:

$$0.15 * {D}_{t , s} \leq {P}_{t , s} \leq {D}_{t , s} , ∀ s ∈ S , ∀ t ∈ T$$

S3.2.4, setting a number of passengers who don't get off at a certain station s in the certain time period t to be equal to a sum of corresponding passengers who enter stations which are in front of the certain station s before the certain time period t and whose destination stations are behind the certain station s, with the calculation expression as follows:

$${M}_{t , s} = {\sum }_{{s}_{o} ∈ {S}_{s}^{o}} {\sum }_{{s}_{d} ∈ {S}_{s}^{d}} {\sum }_{{t}_{o} ∈ {T}_{s}^{{s}_{o} , {s}_{d}}} ( {P}_{{t}_{o} , {s}_{o}} \cdot {q}_{{t}_{o} , {s}_{o} , {s}_{d}} ) , ∀ s ∈ S , ∀ t ∈ T$$

where M_{t,s} represents a number of passengers who don't get off at the certain station s in the certain time period t, which is a continuous variable defined by the mixed integer programming model of multi-station passenger flow coordinated control; and

Sₛ^{o} represents a set of upstream stations of the stations s; Sₛ^{d} represents a set of downstream stations of the stations s; Tₛ^{s}^{ₒ}^{,s}^{_{d}} represents that there is a time period set in which passengers depart from the o^{th} station sₒ to the d^{th} station s_{d}, and the time periods in the set meet the requirement that when time increases to the time periods t, passengers are capable of arriving at the stations s; qₜ_{ₒ}_{,s}_{ₒ}_{,s}_{_{d}} represents a passenger flow proportion of passengers departing from the o^{th} station sₒ and arriving at the d^{th} station s_{d} in a time period tₒ; and Pₜ_{ₒ}_{,s}_{ₒ} represents an optimal number of passengers who boards at a station sₒ in the time period tₒ.

Further, step S4 specifically includes the following steps:
S4.1, linearly relaxing the mixed integer programming model of multi-station passenger flow coordinated control obtained in step S3 into a linear programming model, i.e., allowing a value of P_{t,s} to be an integer, which is denoted as a relaxation model, and obtaining an optimal solution of linear programming by invoking a simplex algorithm to solve;
S4.2, selecting, according to the requirement that P_{t,s} needs to meet an integer feasible region thereof, any non-integer solution variable from P_{t,s} for binary division, adding a constraint P_{t,s}≤└P_{t,s}┘ to the relaxation model in step S4.1 to obtain a sub-problem 1 model, denoted as sub-problem 1, and adding a constraint P_{t,s}>┐P_{t,s}┌ to the relaxation model in step S4.1 to obtain a sub-problem 2 model, denoted as sub-problem 2, and solving by invoking the simplex algorithm separately;
S4.3, calculating a value of an objective function Σ_{t∈T}Σ_{s∈S}A_{t,s}(D_{t,s}−P_{t,s}) in the sub-problem 1 or sub-problem 2 obtained in step S4.2, and taking a maximum value as a lower bound value of the objective function of the mixed integer programming model of multi-station passenger flow coordinated control; and
S4.4, performing further branching for the sub-problems that the value of the objective function is greater than or equal to the lower bound value of the objective function of the mixed integer programming model of multi-station passenger flow coordinated control and the solution is a non-integer, and repeating steps S4.2, S4.3 and S4.4 until an optimal integer solution is obtained.

In a second aspect, the present disclosure provides an electronic device, including a memory and a processor, where the memory stores a computer program which, when executed by the processor, causes the processor to implement the steps of the coordinated control method for urban rail transit passenger flow.

In a third aspect, the present disclosure provides a storage medium, which is a computer-readable storage medium storing a computer program, where the computer program, when executed by a processor, causes the processor to implement the coordinated control method for urban rail transit passenger flow.

The present disclosure has the following beneficial effects: according to the coordinated control method for urban rail transit passenger flow in the present disclosure, for the characteristic of unbalanced distribution of passengers in peak hours of urban rail transit, the following three key elements are optimized and decided simultaneously: start and end time of passenger flow control, stations under coordinated control, and the size of the controlled passenger flow; and for the difference in risk degree of passenger flow delays at different rail stations in peak hours, a number of passengers arriving at each station is taken as a penalty item for passenger flow delay, achieving the effect of preferential evacuation of large-passenger-flow stations.

### BRIEF DESCRIPTION OF DRAWINGS

FIG. 1 is a schematic flowchart of a coordinated control method for urban rail transit passenger flow in the present disclosure;

FIG. 2 is a schematic diagram showing a comparison of passenger flow restricted within an average of 15 minutes before and after optimization at multiple stations of a coordinated control method for urban rail transit passenger flow in the present disclosure; and

FIG. 3 is a schematic diagram showing a comparison of passenger flow before and after optimization at Qianhaiwan station of a coordinated control method for urban rail transit passenger flow in the present disclosure.

### DETAILED DESCRIPTION

In order to make the purposes, technical schemes and advantages of the present disclosure clearer, the present disclosure will be further described in detail with reference to accompanying drawings and embodiments. It should be understood that the embodiments described here are only intended to explain the present disclosure and are not intended to limit the present disclosure, that is, the embodiments described are only some embodiments, rather than all embodiments of the present disclosure. The components in the embodiments of the present disclosure described and illustrated in the accompanying drawings may be arranged and designed in various different configurations, and the present disclosure may also have other embodiments.

Therefore, the detailed description of embodiments of the present disclosure provided in the accompanying drawings is not intended to limit the claimed scope of the present disclosure, but is only intended to represent the selected embodiments of the present disclosure. All other embodiments obtained by those skilled in the art without creative work based on the embodiments of the present disclosure are within the scope of protection of the present disclosure.

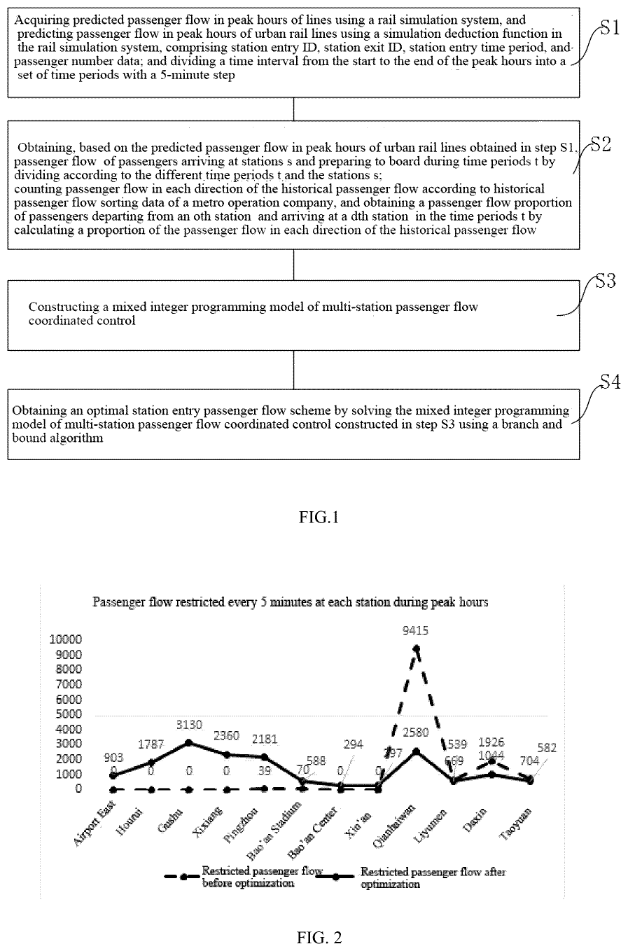

In order to further understand contents, characteristics and effects of the present disclosure, the following embodiments are exemplified and described in detail with reference to FIGS. 1 to 3:

### Embodiment One

Referring to FIG. 1, FIG. 1 is a schematic flowchart of a coordinated control method for urban rail transit passenger flow, including the following steps:
S1, predicted passenger flow in peak hours of lines is acquired using a rail simulation system, and passenger flow in peak hours of urban rail lines is predicted using a simulation deduction function in the rail simulation system, including station entry ID, station exit ID, station entry time period, and passenger number data; and a time interval from the start to the end of the peak hours is divided into a set of time periods with a 5-minute step, denoted as T;
further, based on a dynamic perception system of Shenzhen rail transit operation, predicted passenger flow in peak hours of a certain line is acquired.
S2, based on the predicted passenger flow in peak hours of urban rail lines obtained in step S1, passenger flow A_{t,s} of passengers arriving at stations s and preparing to board in time periods t is obtained by dividing according to the different time periods t and the stations S;
passenger flow in each direction of the historical passenger flow is counted according to historical passenger flow sorting data of a metro operation company, and a passenger flow proportion q_{t,s}_{ₒ}_{,s}_{_{d}} of passengers departing from an o^{th} station sₒ and arriving at a d^{th} station s_{d} in the time periods t is obtained by calculating a proportion of the passenger flow in each direction of the historical passenger flow;
further, obtaining the passenger flow proportion q_{t,s}_{ₒ}_{,s}_{_{d}} of passengers departing from the o^{th} station sₒ and arriving at the d^{th} station s_{d} in the time periods t by calculating the proportion of the passenger flow in each direction of the historical passenger flow in step S2 specifically includes the following step: denoting a number of passengers departing from the o^{th} station sₒ and arriving at the d^{th} station s_{d} in the time periods t in a data set as O_{t,s}_{ₒ}_{,s}_{_{d}}, and denoting a number of all passengers departing from the o^{th} station sₒ as Q_{t,s}_{ₒ}, so the calculation expression of the passenger flow proportion q_{t,s}_{ₒ}_{,s}_{_{d}} of the passengers departing from the o^{th} station sₒ and arriving at the d^{th} station s_{d} in the time periods t is:

$${q}_{t , {s}_{o} , {s}_{d}} = \frac{{O}_{t , {s}_{o} , {s}_{d}}}{{Q}_{t , {s}_{o}}} .$$

S3, a mixed integer programming model of multi-station passenger flow coordinated control is constructed; step S3 specifically includes the following steps:
S3.1, the mixed integer programming model of multi-station passenger flow coordinated control is constructed, with the calculation expression as follows:

$$min {\sum }_{t ∈ T} {\sum }_{s ∈ S} {A}_{t , s} ( {D}_{t , s} - {P}_{t , s} )$$

where min represents a minimization function, and S represents a set of stations;
D_{t,s} represents an actual boarding demand at the stations s in the time periods t, including a number of passengers arriving at the stations in the time periods t and a number of passengers stranded in previous time periods, which is an integer variable of the mixed integer programming model of multi-station passenger flow coordinated control; and
P_{t,s} represents an optimal number of passengers who board at the stations s in the time periods t, which is an integer variable of the mixed integer programming model of multi-station passenger flow coordinated control;
S3.2, constraints of the mixed integer programming model of multi-station passenger flow coordinated control are constructed.

Step S3.2 specifically includes the following steps:
S3.2.1, an actual boarding demand for passenger flow in a first time period at the beginning of peak hours is set to be equal to passenger flow of passengers arriving at the stations and preparing to board in the first time period at the beginning of the peak hours, with the calculation expression as follows:

D_{1,s}=A_{1,s},∀s∈S
where D_{1,s} represents the actual boarding demand at the stations s in the first time period at the beginning of the peak hours, and A_{1,s} represents the passenger flow of passengers arriving at the stations s and preparing to board in the first time period at the beginning of the peak hours;
S3.2.2, an actual boarding demand for passenger flow in a certain time period tis set to be equal to a sum of passenger flow of passengers arriving at the stations and preparing to board in the certain time period t and passenger flow of passengers stranded in a previous time period of the certain time period t, with the calculation expression as follows:

$${D}_{t , s} = {A}_{t , s} + ( {D}_{t - 1 , s} - {P}_{t - 1 , s} ) , ∀ s ∈ S , ∀ t ∈ T , t > 1$$

where D_{t-1,s} represents the actual boarding demand at the stations s in the previous time period of the certain time period t, and P_{t-1,s} represents an optimal number of passengers boarding at the stations s in the previous time period of the certain time period t;
S3.2.3, an upper/lower bound of optimal station entry passenger flow is set, where a value of the upper/lower bound of the optimal station entry passenger flow is greater than or equal to 0.15 times of the actual boarding passenger flow, and less than or equal to the actual boarding passenger flow, with the calculation expression as follows:

$$0.15 * {D}_{t , s} \leq {P}_{t , s} \leq {D}_{t , s} , ∀ s ∈ S , ∀ t ∈ T$$

S3.2.4, a number of passengers who don't get off at a certain station s in the certain time period t is set to be equal to a sum of corresponding passengers who enter stations which are in front of the certain station s before the certain time period t and whose destination stations are behind the certain station s, with the calculation expression as follows:

$${M}_{t , s} = {\sum }_{{s}_{o} ∈ {S}_{s}^{o}} {\sum }_{{s}_{d} ∈ {S}_{s}^{d}} {\sum }_{{t}_{o} ∈ {T}_{s}^{{s}_{o} , {s}_{d}}} ( {P}_{{t}_{o} , {s}_{o}} \cdot {q}_{{t}_{o} , {s}_{o} , {s}_{d}} ) , ∀ s ∈ S , ∀ t ∈ T$$

where M_{t,s} represents a number of passengers who don't get off at the certain station s in the certain time period t, which is a continuous variable defined by the mixed integer programming model of multi-station passenger flow coordinated control; and
Sₛ^{o} represents a set of upstream stations of the stations s; Sₛ^{d} represents a set of downstream stations of the stations s; Tₛ^{s}^{ₒ}^{,s}^{_{d}} represents that there is a time period set in which passengers depart from the o^{th} station sₒ to the d^{th} station s_{d}, and the time periods in the set meet the requirement that when time increases to the time periods t, passengers are capable of arriving at the stations s; qₜ_{ₒ}_{,s}_{ₒ}_{,s}_{_{d}} represents a passenger flow proportion of passengers departing from the o^{th} station sₒ and arriving at the d^{th} station s_{d} in a time period tₒ; and Pₜ_{ₒ}_{,s}_{ₒ} represents an optimal number of passengers who boards at a station sₒ in the time period tₒ.

S4, an optimal station entry passenger flow scheme is obtained by solving the mixed integer programming model of multi-station passenger flow coordinated control constructed in step S3 using a branch and bound algorithm.

Further, step S4 specifically includes the following steps:
S4.1, the mixed integer programming model of multi-station passenger flow coordinated control obtained in step S3 is linearly relaxed into a linear programming model, i.e., a value of P_{t,s} is allowed to be an integer, which is denoted as a relaxation model, and an optimal solution of linear programming is obtained by invoking a simplex algorithm to solve;
S4.2, according to the requirement that P_{t,s} needs to meet an integer feasible region thereof, any non-integer solution variable is selected from P_{t,s} for binary division, a constraint P_{t,s}≤└P_{t,s}┘ is added to the relaxation model in step S4.1 to obtain a sub-problem 1 model, denoted as sub-problem 1, and a constraint P_{t,s}≥┌P_{t,s}┐ is added to the relaxation model in step S4.1 to obtain a sub-problem 2 model, denoted as sub-problem 2, which is solved by invoking the simplex algorithm separately;
S4.3, a value of an objective function Σ_{t∈T}Σ_{s∈S}A_{t,s}(D_{t,s}−P_{t,s}) in the sub-problem 1 or sub-problem 2 obtained in step S4.2 is calculated, and a maximum value is taken as a lower bound value of the objective function of the mixed integer programming model of multi-station passenger flow coordinated control; and
S4.4, further branching is performed for the sub-problems that the value of the objective function is greater than or equal to the lower bound value of the objective function of the mixed integer programming model of multi-station passenger flow coordinated control and the solution is a non-integer, and repeating steps S4.2, S4.3 and S4.4 until an optimal integer solution is obtained.

The coordinated control method for urban rail transit passenger flow in the embodiment is based on the passenger flow data in morning peak hours of Shenzhen Metro Line 1. The total passenger flow (number of boarding passengers) served by trains at each station is counted and compared: 7:30-9:30, which is a time interval with the highest passenger flow pressure in the morning peak, is selected for analysis. After a coordinated passenger flow restriction strategy is implemented, the number of passengers served in the morning peak in the section from Qianhaiwan station to Taoyuan station is increased by 7919, the number of passengers served in the morning peak in the section from Xixiang station to Xin'an station is decreased by 3021, and the total number of passengers served in the morning peak is increased by 4909. The comparison is shown in Table 1:

TABLE 1
Comparison of Total Passenger Flow Served by
Trains at Each Station (Passenger Number)

| | Uncoordinated | Optimal single-line |
|---|---|---|
| | passenger flow | coordinated |
| | restriction | passenger flow |
| Stations | strategy | restriction strategy |
| Airport East | 4548 | 4559 |
| Station | | |
| Hourui Station | 9091 | 9091 |
| Gushu Station | 25180 | 25180 |
| Xixiang Station | 14697 | 13228 |
| Pingzhou Station | 28518 | 28518 |
| Bao'an | 3492 | 2668 |
| Stadium Station | | |
| Bao'an | 1737 | 1373 |
| Center Station | | |
| Xin'an Station | 1819 | 1455 |
| Qianhaiwan | 36480 | 39933 |
| Station | | |
| Liyumen Station | 1995 | 2877 |
| Daxin Station | 2321 | 5645 |
| Taoyuan Station | 3222 | 3482 |
| Total | 133100 | 138009 |

The comparison of passenger flow under multi-station coordinated control is as shown in FIG. 2: after being optimized by the optimal single-line coordinated passenger flow restriction strategy, the trend of the number of passengers experiencing passenger flow restriction within an average of 15 minutes is more balanced, and there is no such situation where large-scale passengers are stranded before optimization.

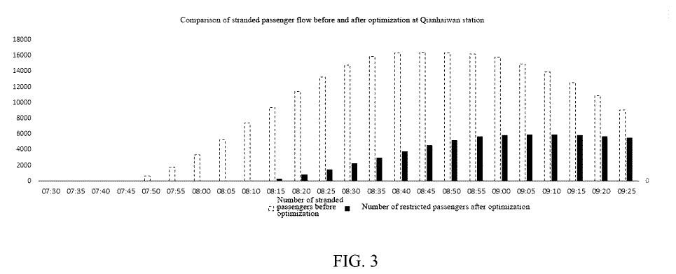

The comparison between the number of boarding passengers and the number of stranded passengers at Qianhaiwan station as a key station is as shown in FIG. 3: due to a large transfer passenger flow at Qianhaiwan station, before the coordinated passenger flow restriction strategy is implemented, the stranded passenger flow (more than 600 passengers) began to appear at 7:50, and the stranded passenger flow increased significantly, which led to an increase in passenger boarding demand in the subsequent time, the cumulative number of passengers gathered in a 5-minute time period (the number of passengers newly arriving at the station in the current time period+the number of passengers stranded in the previous time period) reached 18,019, and the average number of passengers gathered in a 5-minute time period reached 10,934; and after the coordinated passenger flow restriction strategy is implemented, the passenger flow restriction measures (more than 300 passengers) began to appear at 8:15, the maximum number of passengers gathered in a 5-minute period was 7,259, and the average number of passengers gathered in every 5 minutes was 4,400.

### Embodiment Two

An electronic device includes a memory and a processor. The memory stores a computer program, and the processor, when executing the computer program, implements the steps of the coordinated control method for urban rail transit passenger flow in the embodiment one.

A computer device in the present disclosure may be a device including a processor and a memory, such as a microcontroller containing a central processing unit. Moreover, the processor, when executing the computer program stored in the memory, implements the steps of the above-mentioned coordinated control method for urban rail transit passenger flow.

The processor may be a central processing unit (CPU), or may be a general-purpose processor, a digital signal processor (DSP), an application specific integrated circuit (ASIC), a field programmable gate array (FPGA), a programmable logic device, a discrete gate or a transistor logic device, a discrete hardware component, or the like. The general-purpose processor may be a microprocessor or any conventional processor or the like.

The memory may mainly include a program storage area and a data storage area. The program storage area may store an operating system, an application program required for at least one function (such as a sound playing function, an image playing function or the like), etc. The data storage area may store data (such as audio data, phone book or the like) created based on the use of a mobile phone. In addition, the memory may include a high-speed random access memory, and may also include a non-volatile memory such as a hard disk, a memory, a plug-in hard disk, a smart media card (SMC), a secure digital (SD) card, a flash card, at least one disk storage device, a flash device, or other volatile solid-state storage devices.

### Embodiment Three

A storage medium is stored with a computer program thereon. The computer program, when executed by a processor, implements the coordinated control method for urban rail transit passenger flow in the embodiment one.

The computer-readable storage medium in the present disclosure may be any form of storage medium that is read by a processor of a computer device, including but not limited to a non-volatile memory, a volatile memory, a ferroelectric memory, etc. The computer-readable storage medium stores a computer program, and when reading and executing the computer program stored in the memory, the processor of the computer device implements the steps of the above-mentioned coordinated control method for urban rail transit passenger flow described above.

The computer program includes computer program codes which may be in the form of source codes, object codes, executable files or certain intermediate forms, and the like. The computer-readable medium may include any entity or device capable of carrying the computer program codes, a recording medium, a USB flash disk, a portable hard disk, a magnetic disk, an optical disk, a computer memory, a read-only memory (ROM), a random access memory (RAM), an electric carrier signal, a telecommunication signal, and a software distribution medium. It is to be noted that the content contained in the computer-readable medium may be added or removed as appropriate according to the requirements of legislation and patent practice in the jurisdiction. For example, in some jurisdictions, according to the legislation and patent practice, the computer-readable medium does not include electric carrier signals and telecommunication signals.

It is to be noted that relational terms such as “first”, “second” and the like are only used to distinguish one entity or operation from the other entity or operation, and do not necessarily require or imply that there is any actual relationship or order between the entities or operations. Moreover, the terms “including”, “containing” or any other variation thereof are intended to cover a non-exclusive inclusion, such that a process, method, article or device including a series of elements includes not only those elements but also other elements not expressly listed, or elements that are inherent to such process, method, article or device. In the absence of more restrictions, an element defined by the phrase “including one . . . ” does not exclude the existence of additional identical elements in the process, method, article or device that includes the element.

Although the present disclosure has been described above with reference to embodiments, various improvements can be made thereto and the components therein can be replaced with equivalents without departing from the scope of the present disclosure. In particular, as long as there are no structural conflicts, the features in the various embodiments disclosed in the present disclosure can be combined with each other in any way for use, but for the sake of saving space and resources, the cases of the combinations are not exhaustively described in the specification. Therefore, the present disclosure is not limited to the embodiments disclosed herein, but includes all technical schemes falling within the scope of the claims.

What is claimed is:

1. A coordinated control method for urban rail transit passenger flow, comprising the following steps:
S1, acquiring predicted passenger flow in peak hours of lines using a rail simulation system, and predicting passenger flow in peak hours of urban rail lines using a simulation deduction function in the rail simulation system, comprising station entry ID, station exit ID, station entry time period, and passenger number data; and dividing a time interval from the start to the end of the peak hours into a set of time periods with a 5-minute step, denoted as T;
S2, obtaining, based on the predicted passenger flow in peak hours of urban rail lines obtained in step S1, passenger flow A_{t,s} of passengers arriving at stations s and preparing to board in time periods t by dividing according to the different time periods t and the stations s; and
counting passenger flow in each direction of the historical passenger flow according to historical passenger flow sorting data of a metro operation company, and obtaining a passenger flow proportion q_{t,s}_{ₒ}_{,s}_{_{d}} of passengers departing from an o^{th} station sₒ and arriving at a d^{th} station s_{d} in the time periods t by calculating a proportion of the passenger flow in each direction of the historical passenger flow;
S3, constructing a mixed integer programming model of multi-station passenger flow coordinated control; and
S4, obtaining an optimal station entry passenger flow scheme by solving the mixed integer programming model of multi-station passenger flow coordinated control constructed in step S3 using a branch and bound algorithm.

2. The coordinated control method for urban rail transit passenger flow according to claim 1, wherein obtaining the passenger flow proportion q_{t,s}_{ₒ}_{,s}_{_{d}} of passengers departing from the o^{th} station sₒ and arriving at the d^{th} station s_{d} in the time periods t by calculating the proportion of the passenger flow in each direction of the historical passenger flow in step S2 specifically comprises the following step:
denoting a number of passengers departing from the o^{th} station sₒ and arriving at the d^{th} station s_{d} in the time periods t in a data set as O_{t,s}_{ₒ}_{,s}_{_{d}}, and denoting a number of all passengers departing from the o^{th} station sₒ as Q_{t,s}_{ₒ}, so the calculation expression of the passenger flow proportion q_{t,s}_{ₒ}_{,s}_{_{d}} of the passengers departing from the o^{th} station sₒ and arriving at the d^{th} station s_{d} in the time periods tis:
$${q}_{t , {s}_{o} , {s}_{d}} = \frac{{O}_{t , {s}_{o} , {s}_{d}}}{{Q}_{t , {s}_{o}}} .$$

3. The coordinated control method for urban rail transit passenger flow according to claim 1, wherein step S3 comprises the following steps:
S3.1, constructing the mixed integer programming model of multi-station passenger flow coordinated control, with the calculation expression as follows:
$$min {\sum }_{t ∈ T} {\sum }_{s ∈ S} {A}_{t , s} ( {D}_{t , s} - {P}_{t , s} )$$
wherein min represents a minimization function, and S represents a set of stations;
D_{t,s} represents an actual boarding demand at the stations s in the time periods t, comprising a number of passengers arriving at the stations in the time periods t and a number of passengers stranded in previous time periods, which is an integer variable of the mixed integer programming model of multi-station passenger flow coordinated control; and
P_{t,s} represents an optimal number of passengers who board at the stations s in the time periods t, which is an integer variable of the mixed integer programming model of multi-station passenger flow coordinated control; and
S3.2, constructing constraints of the mixed integer programming model of multi-station passenger flow coordinated control.

4. The coordinated control method for urban rail transit passenger flow according to claim 2, wherein step S3 comprises the following steps:
S3.1, constructing the mixed integer programming model of multi-station passenger flow coordinated control, with the calculation expression as follows:
$$min {\sum }_{t ∈ T} {\sum }_{s ∈ S} {A}_{t , s} ( {D}_{t , s} - {P}_{t , s} )$$
wherein min represents a minimization function, and S represents a set of stations;
D_{t,s} represents an actual boarding demand at the stations s in the time periods t, comprising a number of passengers arriving at the stations in the time periods t and a number of passengers stranded in previous time periods, which is an integer variable of the mixed integer programming model of multi-station passenger flow coordinated control; and
P_{t,s} represents an optimal number of passengers who board at the stations s in the time periods t, which is an integer variable of the mixed integer programming model of multi-station passenger flow coordinated control; and
S3.2, constructing constraints of the mixed integer programming model of multi-station passenger flow coordinated control.

5. The coordinated control method for urban rail transit passenger flow according to claim 3, wherein step S3.2 comprises the following steps:
S3.2.1, setting an actual boarding demand for passenger flow in a first time period at the beginning of peak hours to be equal to passenger flow of passengers arriving at the stations and preparing to board in the first time period at the beginning of the peak hours, with the calculation expression as follows:
D_{1,s}=A_{1,s},∀s∈S
wherein D_{1,s} represents the actual boarding demand at the stations s in the first time period at the beginning of the peak hours, and A_{1,s} represents the passenger flow of passengers arriving at the stations s and preparing to board in the first time period at the beginning of the peak hours;
S3.2.2, setting an actual boarding demand for passenger flow in a certain time period t to be equal to a sum of passenger flow of passengers arriving at the stations and preparing to board in the certain time period t and passenger flow of passengers stranded in a previous time period of the certain time period t, with the calculation expression as follows:
$${D}_{t , s} = {A}_{t , s} + ( {D}_{t - 1 , s} - {P}_{t - 1 , s} ) , ∀ s ∈ S , ∀ t ∈ T , t > 1$$
wherein D_{t-1,s} represents the actual boarding demand at the stations s in the previous time period of the certain time period t, and P_{t-1,s} represents an optimal number of passengers boarding at the stations s in the previous time period of the certain time period t;
S3.2.3, setting an upper/lower bound of optimal station entry passenger flow, wherein a value of the upper/lower bound of the optimal station entry passenger flow is greater than or equal to 0.15 times of the actual boarding passenger flow, and less than or equal to the actual boarding passenger flow, with the calculation expression as follows:
$$0.15 * {D}_{t , s} \leq {P}_{t , s} \leq {D}_{t , s} , ∀ s ∈ S , ∀ t ∈ T$$
S3.2.4, setting a number of passengers who don't get off at a certain station s in the certain time period t to be equal to a sum of corresponding passengers who enter stations which are in front of the certain station s before the certain time period t and whose destination stations are behind the certain station s, with the calculation expression as follows:
$${M}_{t , s} = {\sum }_{{s}_{o} ∈ {S}_{s}^{o}} {\sum }_{{s}_{d} ∈ {S}_{s}^{d}} {\sum }_{{t}_{o} ∈ {T}_{s}^{{s}_{o} , {s}_{d}}} ( {P}_{{t}_{o} , {s}_{o}} \cdot {q}_{{t}_{o} , {s}_{o} , {s}_{d}} ) , ∀ s ∈ S , ∀ t ∈ T$$
wherein M_{t,s} represents a number of passengers who don't get off at the certain station s in the certain time period t, which is a continuous variable defined by the mixed integer programming model of multi-station passenger flow coordinated control; and
Sₛ^{o} represents a set of upstream stations of the stations s; Sₛ^{d} represents a set of downstream stations of the stations s; Tₛ^{s}^{ₒ}^{,s}^{_{d}} represents that there is a time period set in which passengers depart from the o^{th} station sₒ to the d^{th} station s_{d}, and the time periods in the set meet the requirement that when time increases to the time periods t, passengers are capable of arriving at the stations S; qₜ_{ₒ}_{,s}_{ₒ}_{,s}_{_{d}} represents a passenger flow proportion of passengers departing from the o^{th} station sₒ and arriving at the d^{th} station s_{d} in a time period tₒ; and Pₜ_{ₒ}_{,s}_{ₒ} represents an optimal number of passengers who boards at a station sₒ in the time period tₒ.

6. The coordinated control method for urban rail transit passenger flow according to claim 4, wherein step S3.2 comprises the following steps:
S3.2.1, setting an actual boarding demand for passenger flow in a first time period at the beginning of peak hours to be equal to passenger flow of passengers arriving at the stations and preparing to board in the first time period at the beginning of the peak hours, with the calculation expression as follows:
D_{1,s}=A_{1,s},∀s∈S
wherein D_{1,s} represents the actual boarding demand at the stations s in the first time period at the beginning of the peak hours, and A_{1,s} represents the passenger flow of passengers arriving at the stations s and preparing to board in the first time period at the beginning of the peak hours;
S3.2.2, setting an actual boarding demand for passenger flow in a certain time period t to be equal to a sum of passenger flow of passengers arriving at the stations and preparing to board in the certain time period t and passenger flow of passengers stranded in a previous time period of the certain time period t, with the calculation expression as follows:
$${D}_{t , s} = {A}_{t , s} + ( {D}_{t - 1 , s} - {P}_{t - 1 , s} ) , ∀ s ∈ S , ∀ t ∈ T , t > 1$$
wherein D_{t-1,s} represents the actual boarding demand at the stations s in the previous time period of the certain time period t, and P_{t-1,s} represents an optimal number of passengers boarding at the stations s in the previous time period of the certain time period t;
S3.2.3, setting an upper/lower bound of optimal station entry passenger flow, wherein a value of the upper/lower bound of the optimal station entry passenger flow is greater than or equal to 0.15 times of the actual boarding passenger flow, and less than or equal to the actual boarding passenger flow, with the calculation expression as follows:
$$0.15 * {D}_{t , s} \leq {P}_{t , s} \leq {D}_{t , s} , ∀ s ∈ S , ∀ t ∈ T$$
S3.2.4, setting a number of passengers who don't get off at a certain station s in the certain time period t to be equal to a sum of corresponding passengers who enter stations which are in front of the certain station s before the certain time period t and whose destination stations are behind the certain station sₒ with the calculation expression as follows:
$${M}_{t , s} = {\sum }_{{s}_{o} ∈ {S}_{s}^{o}} {\sum }_{{s}_{d} ∈ {S}_{s}^{d}} {\sum }_{{t}_{o} ∈ {T}_{s}^{{s}_{o} , {s}_{d}}} ( {P}_{{t}_{o} , {s}_{o}} \cdot {q}_{{t}_{o} , {s}_{o} , {s}_{d}} ) , ∀ s ∈ S , ∀ t ∈ T$$
wherein M_{t,s} represents a number of passengers who don't get off at the certain station s in the certain time period t, which is a continuous variable defined by the mixed integer programming model of multi-station passenger flow coordinated control; and
Sₛ^{o} represents a set of upstream stations of the stations s; Sₛ^{d} represents a set of downstream stations of the stations s; Tₛ^{s}^{ₒ}^{,s}^{_{d}} represents that there is a time period set in which passengers depart from the o^{th} station sₒ to the d^{th} station s_{d}, and the time periods in the set meet the requirement that when time increases to the time periods t, passengers are capable of arriving at the stations s; qₜ_{ₒ}_{,s}_{ₒ}_{,s}_{_{d}} represents a passenger flow proportion of passengers departing from the o^{th} station sₒ and arriving at the d^{th} station s_{d} in a time period tₒ; and Pₜ_{ₒ}_{,s}_{ₒ} represents an optimal number of passengers who boards at a station sₒ in the time period tₒ.

7. The coordinated control method for urban rail transit passenger flow according to claim 1, wherein step S4 comprises the following steps:
S4.1, linearly relaxing the mixed integer programming model of multi-station passenger flow coordinated control obtained in step S3 into a linear programming model, i.e., allowing a value of P_{t,s} to be an integer, which is denoted as a relaxation model, and obtaining an optimal solution of linear programming by invoking a simplex algorithm to solve;
S4.2, selecting, according to the requirement that P_{t,s} needs to meet an integer feasible region thereof, any non-integer solution variable from P_{t,s} for binary division, adding a constraint P_{t,s}≤└P_{t,s}┘ to the relaxation model in step S4.1 to obtain a sub-problem 1 model, denoted as sub-problem 1, and adding a constraint P_{t,s}≥┌P_{t,s}┐ to the relaxation model in step S4.1 to obtain a sub-problem 2 model, denoted as sub-problem 2, and solving by invoking the simplex algorithm separately;
S4.3, calculating a value of an objective function Σ_{t∈T}Σ_{s∈S}A_{t,s}(D_{t,s}−P_{t,s}) in the sub-problem 1 or sub-problem 2 obtained in step S4.2, and taking a maximum value as a lower bound value of the objective function of the mixed integer programming model of multi-station passenger flow coordinated control; and
S4.4, performing further branching for the sub-problems that the value of the objective function is greater than or equal to the lower bound value of the objective function of the mixed integer programming model of multi-station passenger flow coordinated control and the solution is a non-integer, and repeating steps S4.2, S4.3 and S4.4 until an optimal integer solution is obtained.

8. An electronic device, comprising a memory and a processor, wherein the memory stores a computer program which, when executed by the processor, causes the processor to implement the steps of the coordinated control method for urban rail transit passenger flow according to claim 1.

9. A storage medium, which is a computer-readable storage medium storing a computer program, wherein the computer program, when executed by a processor, causes the processor to implement the coordinated control method for urban rail transit passenger flow according to claim 1.
